(19) United States
(12) Patent Application Publication
(10) Pub. No.: US 2010/0019966 A1
(43) Pub. Date: Jan. 28, 2010

(54) Device for identification and geographical location of gamblers for "on line" gambling and their equivalents

(75) Inventor: Raul Eugenio Daneri, Buenos Aires (AR)

Correspondence Address: MEREK, BLACKMON & VOORHEES, LLC, 673 S. WASHINGTON ST, ALEXANDRIA, VA, 22314, US

(73) Assignee: GRUPO AYEX S.R.L.

(21) Appl. No.: 12/458,408

(22) Filed: Jul. 10, 2009

(30) Foreign Application Priority Data
Jul. 25, 2008 (AR) P 20080103253

(51) Int. Cl. G01S 1/00

(52) U.S. Cl. 342/357.06

(57) ABSTRACT

A device formed by electronics containing the general management logics, a “GPS” antenna and its management electronics, a “USB” connector and its driver, and an “RS-232” connector, with the external aspect and size of a “Pen Drive”. It generates an electronic signature that univocally identifies the device. Through the “GPS” antenna, it supplies the geographical location of a device.

### FIELD OF THE INVENTION

The present patent of invention refers to a novel device for the identification and geographical location of gamblers, which could have the technical name of “GPS Player Pen”, belonging to the field of media, resources and accessories suitable to be applied to on line gambling, both trivia and other entertainment and games of chance, as well as to be applied in electronic and electromechanical machines used in Gambling Rooms of Bingos and Casinos.

### BACKGROUND ART

Within a context that has seen on line gambling activity grow, the need arose to set a specific and unique legal frame in the international agenda.

In fact, the proper characteristics of “on line” gambling generates “per se” a complex problem series, added to the natural regulation of the sector.

The main critics of firms administering the “on line” gambling come from the traditional Lottery Agencies, which accuse these sites of unfair competence, since, with lower costs they get a higher operating field, with no special tax requirements.

Likewise, the organization of this kind of gambling and events is being specially analyzed by auditing bodies, since they were not able to install an efficient “system” to control the tax submissions.

One of the jurisdictional problems faced by the activity is set because usually the legal domicile of the gambling Administering Firm and the domicile from where they are administered and controlled do not match.

On the other side, the Administering Firm could have a license to take bets from clients domiciled in zones where some kinds of games are forbidden, which generates a great difficulty for the receipt and collection of taxes.

This way, a truly unfair situation is set before other activities where both firms and Clients thereof should assume tax charges related with the geographical origin of each transaction and also within its location.

It might be said that these inconveniences are a direct consequence of not having the resources or means to truly verify the origin of each transaction and, above all, the geographical region where it was originated.

### BRIEF DESCRIPTION OF THE INVENTION

The device for Identification and geographical location of gamblers referred to in the present patent of invention has been especially conceived to, through it, rapidly determine the geographical location of each client when he is ready to participate in the game, so that it is possible to apply the corresponding restrictions, related with the laws and regulations for each region.

The invented device for identification includes a novel technological means capable to know and inform rapidly the geographical location of the client, in order to apply the corresponding restrictions before authorizing bets, as well as to inform of each event, in a real time, to the Bodies in charge of the auditing and control of gambling.

The invented device for identification supplies for the following functional advantages, i.e.:
It allows, in a reliable manner, for the identification and localization of the client who is ready to be part of the game, before performing a bet.
To provide for his geographical location using the GPS technology (“Global Positioning System”), which allows for the determination around the world of the location of an object with a precision of a few meters.
On the other side, it guarantees for the right identification of the device used in the mechanism of electronic signature, through which some aspects of the security and integrity of the information are satisfied, as well as the authenticity of the origin of the message and not blocking of same.
Additionally, since the invention supplies for an univocal identification means, it is possible to apply it to the gambling in Bingo and Casino Rooms (“EGMs”) as a means to identify gamblers in different systems, such as those usually named “Cashless” or “Player Tracking”.

In order to put the above mentioned objective and advantages into practice, the device for identification and geographical location of gamblers referred to by the present patent of invention, is made from electronics containing the general management logics, a “GPS” antenna and its management electronics, a first connector, such as a “USB” connector, and its “driver”, and a second connector, such as an “RS-232” connector.

The invented device may show an outer aspect of different configuration, within a size similar to the one for a “Pen Drive”.

### INVENTIVE ACTIVITY

No resource for the identification of persons, as known up to date, proposes, and not even suggests, the constructive solution arisen from the above-mentioned paragraphs. Thus, this is a proposal which, besides being novel, has a clear inventive activity.

### BRIEF DESCRIPTION OF DRAWINGS

In order to make concrete the above mentioned advantages, to which users and those skilled in the art may add many others, and in order to facilitate the comprehension of the constructive, constitutive and functional characteristics of the invented device, below is a preferred example of an embodiment which is illustrated, schematically and without a specific scale, in the enclosed drawings, with the express statement that, exactly for being an example, it is not applicable to set a limitative or exclusive scope of protection to it by the present patent of invention, but they simply act as merely explicative and illustrative of the basic conception thereof.

FIG. 1 is a construction and functional diagram showing the invented device in its basic means combination.

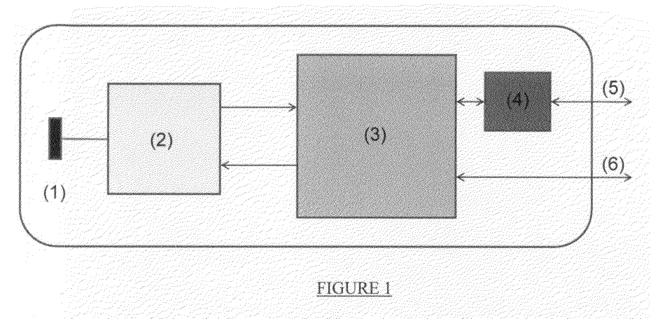

### DESCRIPTION OF A PREFERRED EMBODIMENT

As stated above, the invented device for identification and positioning has an outer form, in aspect and size, similar to a “Pen Drive”, which has a “USB” connector for the connection (5) con a “PC” which allows to enter an “on line” game, and an RS-232 (6) connector for its connection with “EGMs” device in a gambling room.

Inside, the invented device includes a “GPS” antenna (1) with the electronic installation (2) (MN1010 “GPS” “Receiver”) which uses, for its functioning, the “driver” of the USB port (4) (USB LC8 2P6) and the main electronics (3) (such as an STM 32 F103C6 ARM microcontroller, with a 128 KB FLASH memory) having the device logics.

It is specially noted that it does not illustrate or describe the electronic installation referred to (2) as neither does the named main electronics (3) since they are, in themselves, known in the art.

The invention refers to a combination of means set forth to achieve an efficient application in the control and management of “on line” bet gambling, trivia and their equivalents.

In such a sense, it is shown that a built in antenna will be used, of the type “Chip Antenna”, advantageously being the smallest in the market, and that the reception capacity does not depend on the location of the antenna as regards the earth plane (it does not need to be in vertical position like the other models).

Even though said antenna (1) does not have the precision of the other type of antennas, it perfectly satisfies the requirements of the invention.

The invented device uses a sign-in electronic signature, of the type which identifies, univocally to the device, such that it may be used as identification means either for room gambling as well as for online gambling.

From the above, it arises that, through the “GPS” antenna (1) the geographical location of a device is supplied, such that it restricts the gambling to determined areas, and additionally obtains the information for a commercial analysis.

As regards the security of information, it is remarked that the electronic signature mechanism satisfies the above-mentioned aspects of security, integrity of the information, authenticity of the origin of the message and not blocking of origin.

Preferably, a symmetrical algorithm will be used to set the highest security of communications.

As regards the physical security, the external frame is “tampered”, which means that when it is open it stops working definitively.

Additionally, the memory is integrated to the main electronics, such that it protects the program from unauthorized copies.

The proceeding for the entrance of a gambler to the “on line” gambling site is as follows:
There will exist a process for the initialization of the device prior to the game, by means of which a digital certificate will be stored along with the public and private passwords needed to the electronic signature, and the user will be requested to create a personal password for accessing the betting sites.
When the gamer access a bet site “on line”, there will be a function for entering the bet system (“Sign In”). When accessing said function, the site will control the invented device is inserted on any “USB” port of the user computer.
In case a devise is found, a SSL (“Secure Socket Layer”) connection will be started, based in the public and private password exchange between the device and the site and the use of electronic signatures (this proceeding is of standard use in the Web, so that it is not detailed). Additionally, the user will be requested to enter a personal password.
In the event a connection is admitted by the site, i.e., that both the personal password and the electronic signature are correct, the device will inform the current geographical location, obtained through the GPS technology.
The site will validate that the location is admitted according to the agreement of the gamer when purchasing the device.
In case it is the correct location, the gamer will be allowed to start betting.

Having described and determined the nature and the scope of the present invention and the way it should be taken into practice, the invention is claimed as exclusive property as:

1. A DEVICE FOR IDENTIFICATION AND GEOGRAPHICAL LOCATION OF GAMBLERS, FOR “ON LINE” GAMBLING AND THEIR EQUIVALENTS, characterized in that it comprises a combination of a module formed by electronics having the general administration logics, a “GPS” antenna and its management electronics, “USB” connector and its “driver”, and an RS-232 connector.

2. A DEVICE FOR IDENTIFICATION AND GEOGRAPHICAL LOCATION OF GAMBLERS, according to claim 1, characterized in that it externally shows a configuration and a size similar to a “Pen Drive”.

3. A DEVICE FOR IDENTIFICATION AND GEOGRAPHICAL LOCATION OF GAMBLERS, according to claim 1, characterized in that its qualification is generated through an electronic signature which univocally recognizes the device.

4. A DEVICE FOR IDENTIFICATION AND GEOGRAPHICAL LOCATION OF GAMBLERS, according to claim 1, characterized in that it supplies the geographical location of the device through the “GPS” antenna.
